(19) United States
(12) Patent Application Publication
(10) Pub. No.: US 2008/0196709 A1
(43) Pub. Date: Aug. 21, 2008

(54) COMBINATION GRILL HANDLE AND LIGHT

(75) Inventors: Mark E. Davis, Midland, GA (US); Michael Steven Joss, Chicago, IL (US); Marcus Bosch, Chicago, IL (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: CHAR-BROIL LLC, Columbus, GA (US)

(21) Appl. No.: 11/675,791

(22) Filed: Feb. 16, 2007

(51) Int. Cl. A47J 37/00

(52) U.S. Cl. 126/39 BA

(57) ABSTRACT

A grill handle and light assembly is disclosed, the handle being attached to the lid of the grill and the light being detachably secured to the handle for use while grilling or, when detached, as an auxiliary light.

### TECHNICAL FIELD

The present invention is generally relates to a combination handle and light assembly for use with a barbecue grill.

### DESCRIPTION OF THE RELATED ART

Outdoor grilling is a very popular endeavor with millions of barbecue grills sold every year in this country and around the world. Barbecue grills come in many shapes and sizes ranging from small disposable grills made for use when camping or backpacking to large models that can be installed into a structural element on a patio or deck and used as an outdoor kitchen. Heat for cooking is supplied either by charcoal, gas, or electrically heated elements, and in some cases, a combination of heat sources are employed in a single unit. Typically, the larger the grill, the more features it includes, such as side burners, rotisseries, warming bins, smoking chambers, etc.

The versatility of outdoor cooking often lends itself to the use of the grill after dark. Many attempts have been made to provide light for illuminating the grill and the food being cooked thereon at night. There are three broad categories of lights found in the prior art. The first category consists of grill lights (electric) where the light source is mounted to the side of the grill. The second category consists of grill lights (electric) where the light source is mounted above the grill. The final category consists of grill lights that use gas for illumination rather than electricity.

In the first category, U.S. Pat. No. 3,992,618 to Matthews, et al., discloses a light support, in which a lamp is mounted to a gooseneck portion of the light support and a c-clamp attaches the light support to the side of the grill. Another example is shown by U.S. Pat. No. 5,823,658 to Doddy, in which an anchorable support for a flashlight is attached to a end portion or side shelf of a grill. In this patent, a gooseneck having a flashlight securing ring is mounted on a bracket which is then clamped to the grill or the sideshelf. Another example is shown by U.S. Pat. No. 5,664,875 to Hegedus, disclosing a grill light with a housing and a mounting device. A light assembly mounts to the upper end of a flexible gooseneck shaft and the lower end of the shaft connects to the housing. An insulated wand allows the light assembly to be directed at the cooking grate.

The second category involves light sources that are mounted above the grill in some fashion. U.S. Pat. No. 3,291,114 to Metcalf, discloses a charcoal grill with a food support, a rotisserie, and an exhaust hood. An exhaust fan and a light are mounted in the exhaust hood. U.S. Pat. No. 2,809,282 to Cripe, et al., discloses a cooking stove with a light. The cooking stove includes a cooking surface and a back rail. The overhang of the back rail houses a light source which includes two electric lamps and a reflector. The reflector directs light downward and forward onto the cooking surface. An example of a light incorporated with a grill handle is found in U.S. Pat. No. 5,257,169 to Walendziak, which shows a lighting apparatus fixed to an upper grill housing. The lighting apparatus is adjacent and below the handle to direct illumination onto an underlying grate. The illumination housing includes batteries and a DC generator for recharging the batteries. Another example is shown by U.S. Pat. No. 6,132,055 to Grisamore, et al., which shows a handle assembly mounted to a grill lid. The handle assembly includes a light containing tube. The tube includes a clear plastic outer housing, an inner housing which supports batteries, and end caps. The light shines on the cooking surface when the lid is raised to access the cooking chamber.

The third category of lights are gas lights which share the fuel source with the barbecue grill. An early example is U.S. Pat. No. 3,524,980 to Meloan, which shows an outdoor gas grill combined with a gas light. A horizontal support arm attaches to the supporting post of the gas light. The grill is rotatably mounted to the support arm which is rotatably mounted to the post. Another example is shown by U.S. Pat. No. 6,202,640 to Naperola, et al., which shows a grill light used in conjunction with a conventional outdoor gas grill. The light has an elongated conduit which houses a flexible hose that extends to the combustible fuel container to carry combustible fuel to the light.

Thus, while it can be seen that there have been many attempts to provide a light source for use in barbecue grilling after dark, the solutions found in the prior art have been cumbersome to install and to operate, among other disadvantages. It is to these unaddressed needs that the following disclosure is directed.

### SUMMARY

Disclosed is a portable gas grill cooking apparatus comprising a grill having a hood and a firebox and, in some cases, a cart having wheels for adding mobility to the structure. The grill is lightweight and portable, and is easily transported for convenient use in tailgating or camping activities. The grill may also be used as the main or only grill for a household. The firebox has a handle, into which is incorporated a grill light. The light is to illuminate the cooking surface when the firebox is raised and in this mode, functions as a part of the handle. The light is also built to be removable for use as an auxiliary light for use during grilling or for other activities.

Other features and advantages of the grill handle light will become apparent to one with skill in the art upon examination of the following drawings and detailed description. It is intended that all such additional features and advantages be included herein within the scope of the present disclosure.

### BRIEF DESCRIPTION OF THE DRAWINGS

The grill handle light can be better understood with reference to the following drawings. The components of the drawings are not necessarily to scale, emphasis instead being placed upon clearly illustrating the principles of the grill handle light. Moreover, in the drawings, like reference numerals designate corresponding parts throughout the several views.

FIG. 1 is a perspective view of a portable grill apparatus incorporating the grill handle light.

FIG. 2 is a partial perspective view illustrating the illumination of the cooking surface with the lid open;

FIG. 3 is a partial exploded view illustrating the grill handle light detached from the handle;

FIG. 4A is a partial cross sectional view illustrating an embodiment of a latching mechanism in a locked mode.

FIG. 4B is a partial cross sectional view illustrating an embodiment of a latching mechanism moved to an open position; and

FIG. 5 is a partial perspective view illustrating an embodiment of an opposite end of a latching mechanism.

### DETAILED DESCRIPTION

The present disclosure is generally directed to a handle and light assembly for use on a barbecue grill. The assembly is inclusive of a handle and at least one source of illumination for illuminating a cooking surface inside the cooking chamber of the barbecue grill. The handle may function both as a means for opening the firebox to access the cooking surface and also, when detached, as a source of illumination for the cooking surface, any side shelf components, such as a side burner or griddle, or the surrounding area.

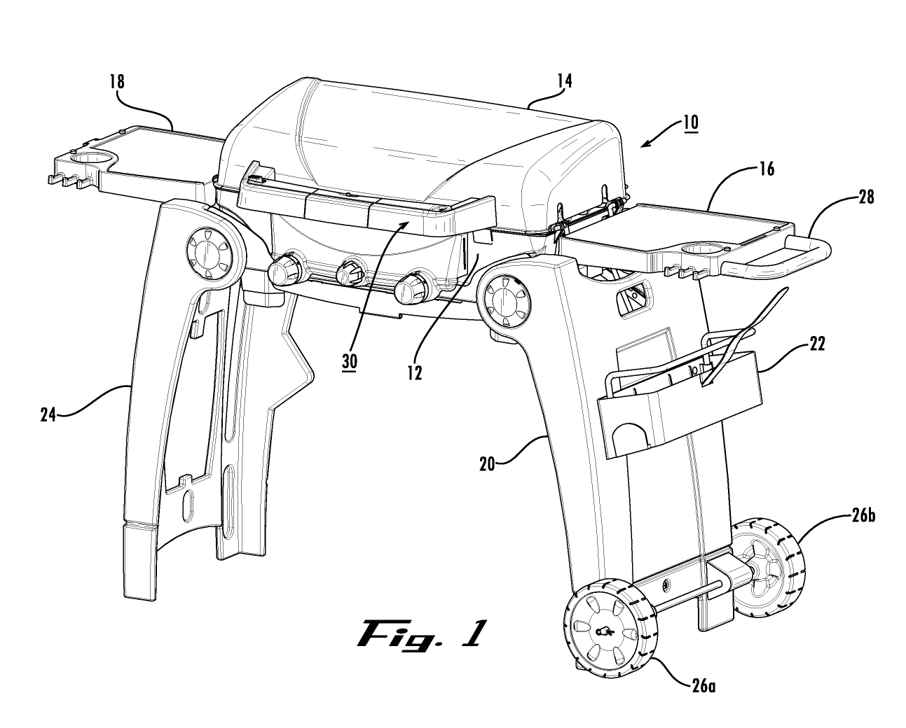

Referring now more specifically to the drawings and to FIG. 1 in particular, numeral 10 designates generally a portable barbecue grill that can be used as the main grill for a household. The grill is also lightweight and designed to be folded into a compact arrangement (not shown) for use in tailgating or camping activities. In its compact shape, the grill easily fits into the back of a truck or sport utility vehicle for ease of transportation. The grill is similar in that respect to that shown in U.S. Pat. No. 6,951,213 to Coleman, et al., the patent being commonly owned by the Assignee of the present disclosed device. The grill includes a lower casting or firebox 12 within which is mounted a burner and gas train (not shown). The burner is supplied with fuel, typically propane or natural gas, from a gas bottle or gas line (not shown). In some instances, the present grill may also be designed for use with charcoal. The firebox is covered by a lid 14 which is normally mounted to the firebox through hinges located on the back side thereof. This particular embodiment includes a right side shelf 16, as viewed from the front of the grill and a left side shelf 18 which can be used for storing food, either before or after cooking, for mounting a sideburner, or even as removable trays for serving purposes.

The grill includes a right leg 20 which has a basket 22 mounted thereto which can be used for condiments, grill brushes, etc. Opposite the right leg is a left leg 24 for supporting the opposite side of the grill. At the lower end of the right leg are wheels 26a and 26b. For transporting the grill, legs 20 and 24 are designed to be rotated inwardly toward each other where they nest beneath the grill. This deploys wheels 26a and 26b on the opposite side from that shown in FIG. 1, whereupon the entire unit can be rolled in a compact state by lifting handle 28, which is mounted on sideshelf 16 and wheeling the grill to any desired location. The lid 14 of the firebox is raised and lowered by means of a handle and light assembly 30.

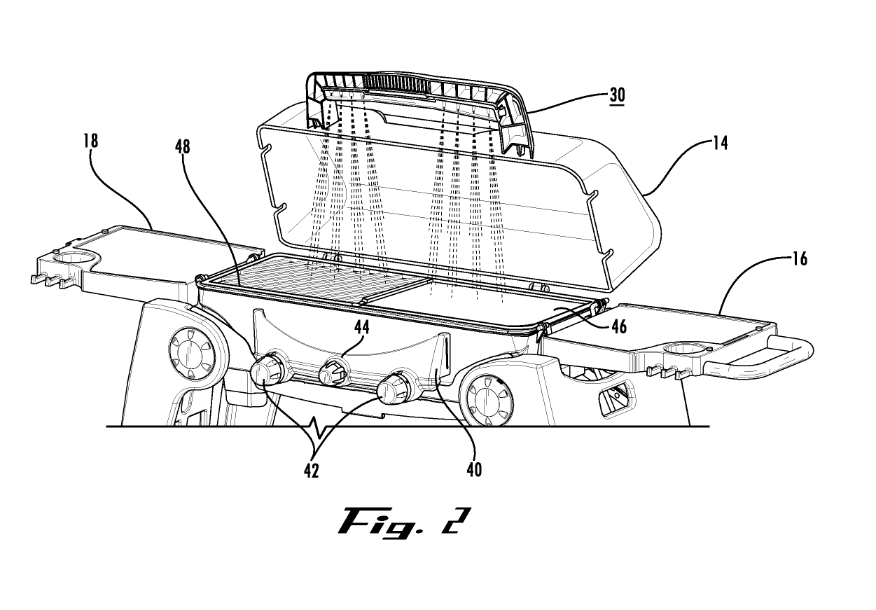

Referring more specifically now to FIG. 2, the grill is shown with the lid 14 in an open position, with the handle and light assembly 30 in position to illuminate the food being cooked. The grill as shown includes a control panel 40 through which are mounted gas valves 42 and an igniter 44 for use in igniting the gas that is delivered to the burner or burners. The cooking surface may comprise a griddle 46 or a cooking grate 48, any combination of these, or any other suitable cooking surface as is known in the prior art.

With the lid in the fully opened position shown in FIG. 2, the lights contained in the handle and light assembly 30 are directed downwardly toward the cooking surface, as illustrated by the dashed lines emanating from the handle and light assembly. This allows the chef, when either placing food on or removing food from the grill, when turning the food, or merely checking the cooking progress, to easily view the cooking surface and the food being cooked thereon, regardless of ambient lighting conditions.

FIG. 3 illustrates an exploded perspective view of the handle and light assembly 30 being separated into handle 50 and light 52. The handle is generally u-shaped with each end secured to the lid of the grill, forming a recess between the connection points for a user to grip the handle. The light is secured to the handle within this recess and, when attached, functions as part of the handle. The light 52 is detachable from the handle for manipulation around the grill or the sideshelves, or simply for use as an auxiliary light, regardless of whether the grill is being used. The light will normally be powered by batteries (not shown), which are inserted through the battery cover housing 54. It is also contemplated that the light could be powered by solar cells. In the embodiment shown, the light is provided by a plurality of bulbs 56 which are shielded by a transparent cover 58. Any number of lights is possible, from a single bulb to multiple bulbs, or other light-emitting means. The light is turned on and off by means of switch 60.

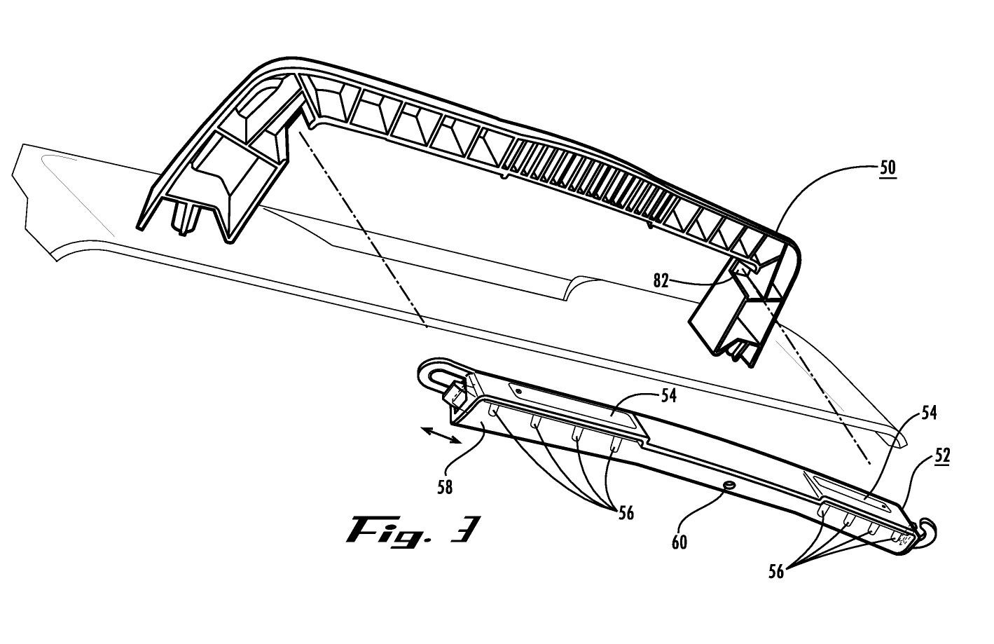

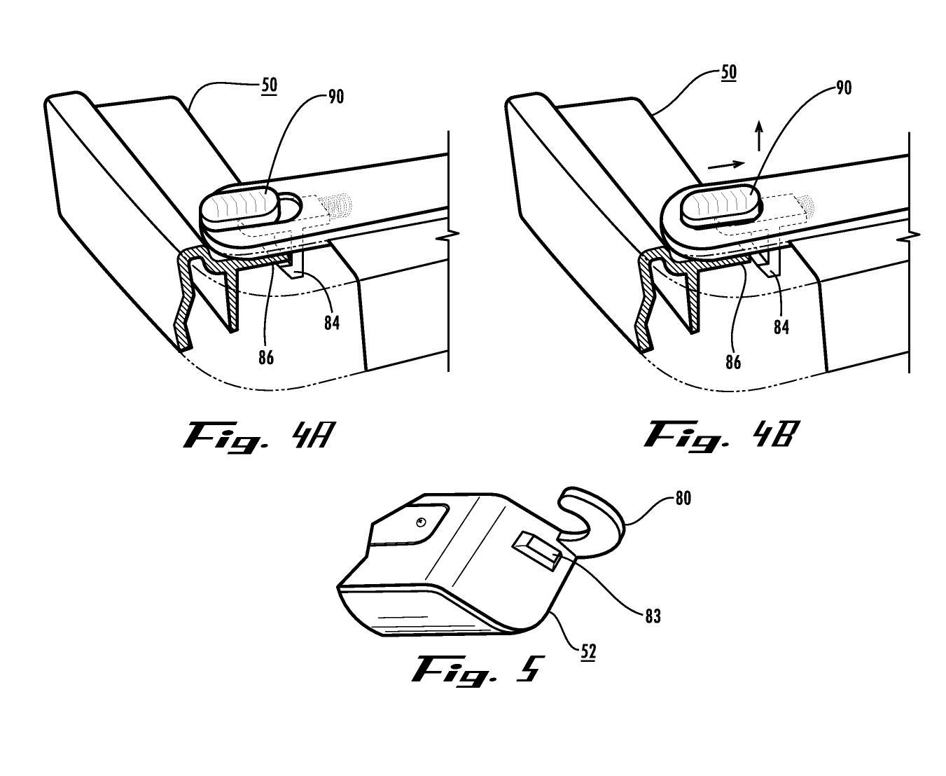

For purposes of illustration, in FIG. 3, the light 52 is shown detached from the handle and oriented below the handle. Installation of the light is accomplished from the top side of the handle 50, the light having an attachment means at each end thereof. Referring to FIGS. 4A, 4B, and 5, as well as FIG. 3, as viewed in the drawings, the light 52 includes an engagement means such as a hook 80 on the right end thereof which is engaged between a tab 82 formed in handle 50, (FIG. 3) and a bumper 83 (FIG. 5), the combination serving to both easily locate the light in the correct position to be secured, and to provide a secure mounting. Upon engaging the hook 80 with the tab 82, the opposite side of the light is snapped into place in handle 50 by means of a securing means such as a latch 84. Latch 84 engages a wall 86 of handle 50 to secure the light in place. The latch 84 is disengaged from the handle by means of a spring loaded latch release 90 which, as shown in FIG. 4B, is slid axially for disengaging latch 84 from wall 86. This permits the light to be lifted upwardly away from the handle for use as an auxiliary light.

Although the description above contains several specific embodiments, these embodiments should not be construed as limiting the scope of the invention but as merely providing illustrations of some of the embodiments of this invention. Thus, the scope of the invention should be determined by the appended claims and their legal equivalents.

Therefore, having thus described the invention, at least the following is claimed:

1. A grill handle and light assembly for use with a barbecue grill, the assembly comprising a handle adapted for mounting to the lid of the grill and a light detachably secured to said handle, said light having an engagement means at one end thereof for engaging said handle, and a securing means at the other end thereof for securing said light to said handle.

2. The assembly of claim 1 in which said light includes a source of energy and a light emitting means.

3. The assembly of claim 2 in which said source of energy includes at least one battery.

4. The assembly of claim 2 in which said source of energy includes at least one solar cell.

5. In a barbecue grill having a firebox and a lid, wherein the improvement comprises, a handle and light assembly with a handle attached to the lid for raising and lowering the lid and a light detachably secured to said handle, said light being oriented to illuminate the cooking area of the grill when the lid is raised.

6. The assembly of claim 5 in which said light includes a source of energy and a light emitting means.

7. The assembly of claim 5 in which said source of energy includes at least one battery.

8. The assembly of claim 7 in which said source of energy includes at least one solar cell.

9. A handle for a barbecue grill, the grill having a firebox with a heat source associated therewith, a cooking surface disposed above the heat source, and a lid for covering and providing access to the cooking surface, the handle comprising a generally u-shaped member with an attachment means at each end thereof for securing said handle to the lid, and a light secured to said handle with a latch for securing and releasing said light from said handle, said light being oriented to illuminate said cooking surface when the lid of the grill is open.

10. A handle as defined in claim 9 said light includes a hook at one end thereof for hanging said light from a suitable support member.
